(19) United States
(12) Patent Application Publication
(10) Pub. No.: US 2026/0087862 A1
(43) Pub. Date: Mar. 26, 2026

(54) SYSTEM, INFORMATION PROCESSING APPARATUS, INFORMATION PROCESSING METHOD, AND STORAGE MEDIUM

(71) Applicant: TOYOTA JIDOSHA KABUSHIKI KAISHA, Toyota-shi (JP)

(72) Inventor: Iwao NITTA, Nagoya-shi (JP)

(73) Assignee: TOYOTA JIDOSHA KABUSHIKI KAISHA, Toyota-shi (JP)

(21) Appl. No.: 19/326,117

(22) Filed: Sep. 11, 2025

(30) Foreign Application Priority Data
Sep. 20, 2024 (JP) 2024-164386

(51) Int. Cl. G07C 5/08; G07C 5/00

(52) U.S. Cl. CPC G07C 5/0825; G07C 5/008

(57) ABSTRACT

An information processing apparatus that provides first information concerning a predetermined target object to a user, the first information being generated based on one or more pieces of data concerning the predetermined target object. The information processing apparatus comprises a storage and a processor. The storage configured to store the one or more pieces of data, user data that is data defining a user accessing the information processing apparatus in association with a user class, and second information defining the first information that can be provided to a user belonging to a predetermined user class. The processor configured to execute when there is access from a user, determining, based on the user data, a user class corresponding to the user, generating, based on the second information, the first information corresponding to the determined user class, and outputting the generated first information to a terminal of the user.

This application claims the benefit of Japanese Patent Application No. 2024-164386, filed on September 20, 2024, which is hereby incorporated by reference herein in its entirety.

### BACKGROUND

### Technical Field

The present disclosure relates to an apparatus that performs information provision.

### Description of the Related Art

There is a technology for managing a supply chain in which a plurality of companies is involved. In this relation, Japanese Patent Laid-Open No. 2004-171146 (Patent document 1) discloses a system that shares information concerning a transaction commodity between a vendor company and a customer company.

### SUMMARY

An object of the present disclosure is to appropriately perform information provision concerning a target object.

One aspect of the present disclosure is that an information processing apparatus that provides first information concerning a predetermined target object to a user, the first information being generated based on one or more pieces of data concerning the predetermined target object, the information processing apparatus comprising:

a storage configured to store:

the one or more pieces of data;

user data that is data defining a user accessing the information processing apparatus in association with a user class; and

second information defining the first information that can be provided to a user belonging to a predetermined user class; and

a processor configured to execute:

when there is access from a user, determining, based on the user data, a user class corresponding to the user;

generating, based on the second information, the first information corresponding to the determined user class; and

outputting the generated first information to a terminal of the user.

One aspect of the present disclosure is an information processing apparatus that provides first information concerning a predetermined target object to a user, the first information being generated based on one or more pieces of data concerning the predetermined target object, the information processing apparatus comprising a processor configured to execute:

when there is access from a user, determining, out of a plurality of user classes defined in advance, a user class corresponding to the user;

generating, based on second information defining the first information that can be provided to the user belonging to the predetermined user class, the first information corresponding to the determined user class; and

providing the generated first information to the user.

One aspect of the present disclosure is an information processing method executed by an information processing apparatus that provides first information concerning a predetermined target object to a user, the first information being generated based on one or more pieces of data concerning the predetermined target object, the information processing method comprising:

when there is access from a user, determining, out of a plurality of user classes defined in advance, a user class corresponding to the user;

generating, based on second information defining the first information that can be provided to a user belonging to a predetermined user class, the first information corresponding to the determined user class; and

providing the generated first information to the user.

Another aspect is a non-transitory storage medium recording a program for causing a computer to execute the above method.

According to the present disclosure, it is possible to appropriately perform information provision concerning a target object.

### BRIEF DESCRIPTION OF THE DRAWINGS

FIG. 1 is a schematic diagram of an information processing system according to a first embodiment;

FIG. 2 is a diagram exemplifying types of data generated concerning a vehicle battery;

FIG. 3 is a diagram illustrating an overview of processing performed between a terminal (a vehicle server) and a management server;

FIG. 4 is a diagram illustrating an overview of processing performed between the terminal (the vehicle server) and the management server;

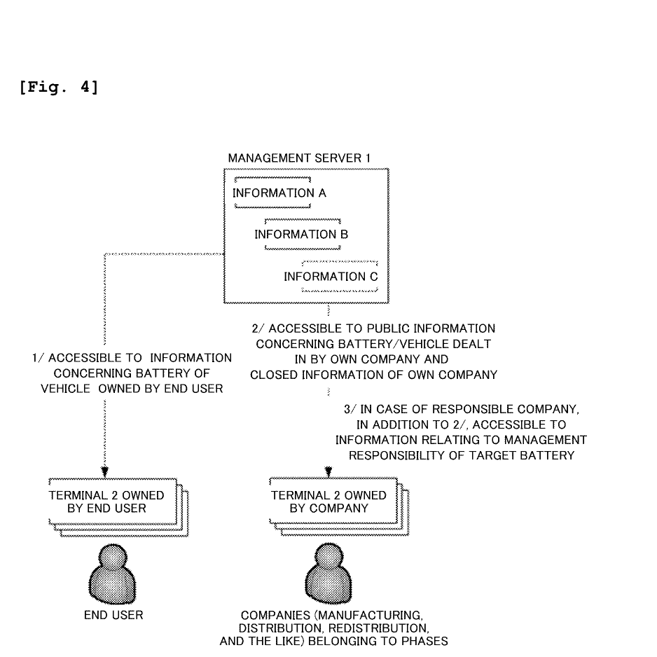

FIG. 5 is a hardware configuration diagram of the management server according to the first embodiment;

FIG. 6 is a hardware configuration diagram of the terminal according to the first embodiment;

FIG. 7 is a hardware configuration diagram of the vehicle server according to the first embodiment;

FIG. 8 is a software configuration diagram of the management server according to the first embodiment;

FIG. 9 is a diagram illustrating an example of data stored in a user management DB;

FIG. 10 is a diagram illustrating an example of data stored in a battery information DB;

FIG. 11 is a diagram illustrating an example of data stored in a provision information DB;

FIG. 12 is a software configuration diagram of the terminal according to the first embodiment;

FIG. 13 is a software configuration diagram of the vehicle server according to the first embodiment;

FIG. 14A is an example of a dashboard screen provided to a user;

FIG. 14B is an example of a dashboard screen provided to the user;

FIG. 15 is an example of a model data screen provided to the user;

FIG. 16 is an example of a BIN data screen provided to the user;

FIG. 17 is a flowchart of processing executed by the management server; and

FIG. 18 is a sequence diagram of processing between the management server and the terminal.

### DESCRIPTION OF THE EMBODIMENTS

In recent years, automobiles that travel using, as an energy source, electric power accumulated in a driving battery, such as a battery electric vehicle (BEV) and a plug-in hybrid vehicle (PHEV), have been increasing.

On the other hand, when an electric vehicle spreads, it becomes important to manage information concerning a driving battery mounted on the electric vehicle (hereinafter simply referred to as battery or referred to as vehicle battery). For example, it is predicted that, according to the spread of the electric vehicle, business for removing a battery from a used car and selling and purchasing the battery will pick up. However, the battery of the used car is likely to damage the environment if not correctly recycled. The used car is not appropriately evaluated unless a state (performance and the like) of the battery cannot be grasped.

For this reason, construction of a platform for centrally managing information concerning batteries for electric vehicles has been examined.

A lifecycle of a vehicle battery involves various companies such as a battery manufacturer, a vehicle manufacturer, a used car dealer, a battery dismantler, and a battery recycler. By collecting information from these companies and centrally controlling and appropriately providing the information, it is possible to increase the values of batteries and electric vehicles and prevent troubles such as a fire accident.

On the other hand, when information is collected from a plurality of companies and centrally managed, access authority has to be appropriately imparted. This is because, since the information concerning the vehicle battery includes design information, personal information of a vehicle user, and information concerning privacy concerning movement, it is unpreferable to provide these pieces of information, without limitation, to the plurality of companies relating to the vehicle battery.

Further, when information provision is performed to a plurality of companies, design of user interface screens is a problem. Since stages involving the plurality of companies in a lifecycle of a battery can be different, user interface screens provided to the companies can also be different. However, it is unrealistic to define user interface screens for each of the companies that are login targets.

An information processing apparatus of the present disclosure solves such a problem.

An information processing apparatus according to an aspect of the present disclosure is an information processing apparatus that provides first information concerning a predetermined target object to a user, the first information being generated based on one or more pieces of data concerning the predetermined target object, the information processing apparatus including a controller configured to execute: when there is access from a user, determining a user class corresponding to the user out of a plurality of user classes defined in advance; generating the first information corresponding to the determined user class based on second information defining the first information that can be provided to a user belonging to a predetermined user class; and providing the generated first information to the user.

The predetermined target object is an article in which, in a lifecycle of the article, a plurality of companies such as a manufacturer, a distributor, and a recycler is involved. The predetermined target object is typically a driving battery designed for an electric vehicle. The driving battery involves many companies that perform, besides the manufacturing and the distribution, removal from a used vehicle, dismantling, refining, rebuilding, rebuilding in a vehicle, building in other than the vehicle, and recycling.

The information processing apparatus is configured to be capable of storing or acquiring the one or more pieces of data concerning the predetermined target object. For example, when a target object is a vehicle battery, in a phase of manufacturing the battery, information concerning a carbon footprint (CFP), information concerning a recycle rate and the like, information concerning due diligence (DD), specification information, and the like can be generated as such information. In a phase of manufacturing a vehicle, model information of the vehicle, design information, information concerning satisfied CFP and DD, and the like can be generated. In a phase of removing the battery from the vehicle, information concerning a dismantler, a dismantling base, a transfer destination of the battery, a transporter, and the like can be generated.

The information processing apparatus centrally manages such data relating to a target object that can be generated in a lifecycle of the target object. These pieces of data are collected from pluralities of companies, users, apparatuses, and the like.

The controller generates the first information concerning the target object based on such data and provides the first information to the plurality of users. Each of the plurality of users may be an end user who owns an electric vehicle or may be a company involved in manufacturing, distribution, dismantling, redistribution, and the like of a battery.

When there is access from a user, the controller determines a user class corresponding to the user out of a plurality of user classes defined in advance. The user class is an attribute of the user and is defined based on, for example, a role (for example, a manufacturer, a distributor, or a recycler) and a responsible area (for example, to which manufacturer the user belongs) of the user for the target object.

The controller generates, based on the second information, the first information corresponding to the determined user class.

The second information is information defining the first information that can be provided to the user belonging to the predetermined user class. The second information may be information defining design of screens provided to users belonging to the user classes and the first information that can be provided to each of the users belonging to the user classes via the screens.

As described above, a user interface screen and information provided by the user interface screen can be described for each of the user classes by the second information. Note that the second information may include a generation logic for the first information that uses the one or more pieces of data.

Specific embodiments of the present disclosure are described below with reference to the drawings. Hardware configurations, module configurations, functional configurations, and the like described in the embodiments are not meant to limit the technical scope of the disclosure only thereto unless particularly described otherwise.

### First Embodiment

An information processing system according to a first embodiment is a system that manages information concerning a vehicle battery designed for an electric vehicle.

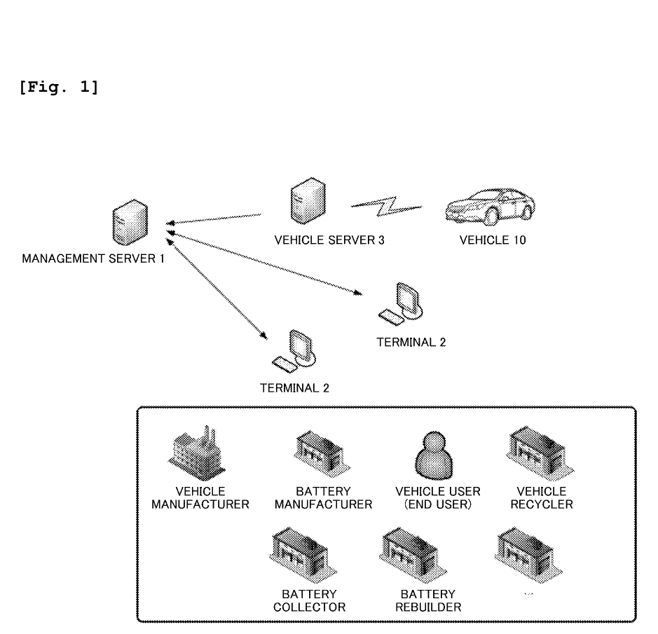

FIG. 1 is a schematic diagram of an information processing system according to the present embodiment. The information processing system according to the present embodiment includes a management server 1, one or more terminals 2, and one or more vehicle servers 3.

The management server 1 is a server apparatus that manages information concerning a target vehicle battery. The management server 1 acquires information concerning the vehicle battery from a plurality of users involved in a lifecycle of the vehicle battery and centrally manages the information. The management server 1 provides the information concerning the battery to these users in response to requests.

The terminal 2 is a terminal apparatus used by a plurality of users involved in the vehicle battery in the lifecycle of the vehicle battery. Examples of the plurality of users involved in the lifecycle of the vehicle battery include an owner (an end user) of a vehicle and a plurality of companies. The companies are companies involved in manufacturing, distribution, recycling, and the like of the battery and include, for example, a vehicle manufacturer, a battery manufacturer, a battery collector, a used car dealer, and a battery recycler. The terminal 2 can provide information concerning the battery to the management server 1 and receive provision of information from the management server 1.

The management server 1 can collect information concerning a management target battery not only from the companies but also from a vehicle mounted with the battery. For example, in order to estimate a state of the battery, information concerning traveling of the vehicle (hereinafter referred to as vehicle traveling information) such as a voltage value, a current value, temperature, and a charging frequency is sometimes necessary. The vehicle server 3 performs communication with a plurality of vehicles 10, collects vehicle traveling information from the plurality of vehicles 10, and provides the vehicle traveling information to the management server 1. Accordingly, the management server 1 is capable of collecting real time data concerning the battery mounted on the vehicle.

Note that the vehicle server 3 may relay the vehicle traveling information to the management server 1 without processing the vehicle traveling information or may perform predetermined arithmetic operation on the collected vehicle traveling information and then transmit the vehicle traveling information to the management server 1.

Subsequently, a plurality of stages included in a lifecycle of a vehicle battery and a plurality of users involved in the stages are described.

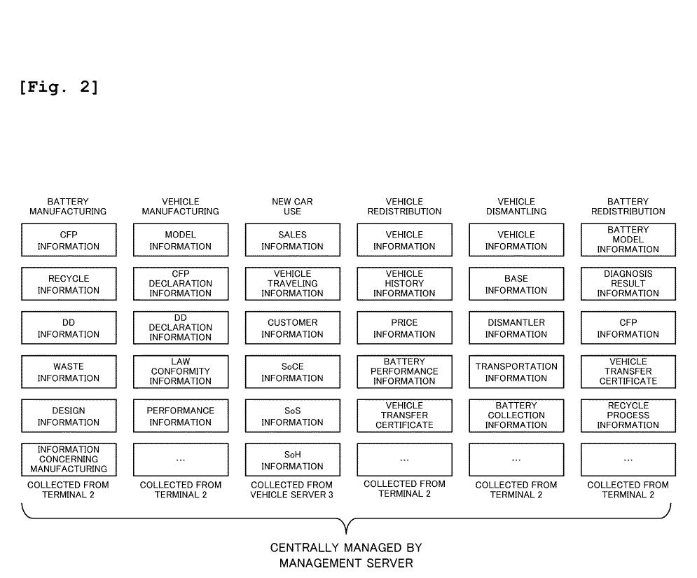

FIG. 2 is a diagram exemplifying the plurality of stages included in the lifecycle of the vehicle battery and types of data (information types) generated at the stages.

For example, at a stage of manufacturing the vehicle battery, information concerning greenhouse effect gas (a carbon footprint (referred to as CFP as well)), information representing a material recycle rate or the like, information concerning responsibility in material procurement (due diligence (referred to as DD as well)), and the like can be generated from a manufacturer of the battery.

At a stage of manufacturing a vehicle, vehicle model information, information concerning adopted CFP rules and DD rules, information concerning law conformity, and the like can be generated from a manufacturer of the vehicle.

At a stage of using a sold new vehicle, information concerning sales of the vehicle, traveling information of the vehicle, customer information, battery status information, and the like can be generated. As the battery status information, certified energy (capacity) (SoCE, state of certified energy), a safety degree (SoS, state of safety) of the battery, a health degree (SoH, state of health) of the battery, and the like can be exemplified. These pieces of information can be calculated from the information (the voltage value, the current value, the temperature, the charging frequency, and the like) acquired from the vehicle.

At a stage of redistributing a used vehicle, vehicle information, history information of the vehicle (a traveling distance, a repair history, and the like), sales price information, battery performance information at the time of resale, a transfer certificate, and the like can be generated from a used car dealer and the like.

At a stage of dismantling the vehicle, vehicle information, base information of a dismantler, information concerning the dismantler, information concerning transportation, information concerning collection of a waste battery, and the like can be generated from a dismantler of the vehicle and the like.

Further, at a stage of reusing a battery removed from a scrapped car, model information of the battery, a diagnosis result of the battery, information concerning a CFP, a transfer certificate of the battery, information concerning a recycle process, and the like can be generated from a recycler of the battery and the like.

The management server 1 according to the present embodiment collects these pieces of information by type from the terminals 2 of the companies or the vehicle 10 (the vehicle server 3) and centrally manages the information. The management server 1 processes and provides these pieces of information in response to a request from the companies and the end user.

Note that, in the present embodiment, companies playing predetermined roles at stages are referred to as "actors". The actors are, for example, a "battery manufacturer", a "vehicle manufacturer", a "vehicle dismantler", and a "battery recycler".

Subsequently, an overview of processing in which the management server 1 collects information is described.

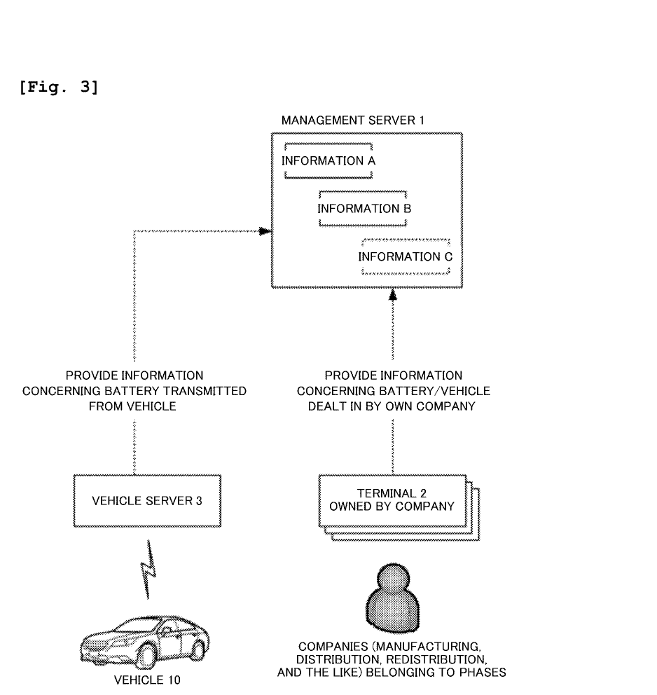

FIG. 3 is a diagram illustrating an overview of information collection processing performed between the terminal 2 or the vehicle server 3 and the management server 1.

In this example, the single vehicle server 3 periodically acquires the information (the voltage value, the current value, the temperature, the charging frequency, and the like) for calculating the status of the battery from the plurality of vehicles 10 that are under the control of the management server 1 and periodically transmits these pieces of information to the management server 1.

The terminals 2 owned by the companies involved in the manufacturing, the distribution, the recycling, and the like of the battery at the respective stages provide the information treated by the own companies to the management server 1. Timing for providing the information may be any timing. For example, the manufacturer of the battery may provide the information at timing when the target battery has been completed. The dismantler of the battery may provide the information at timing when dismantling of the target battery has been completed.

When there is a plurality of companies, a plurality of terminals 2 may be included in the system. Each of the pieces of information transmitted from the terminals 2 and the vehicle server 3 is stored in a database included in the management server 1.

Subsequently, an overview of processing in which the management server 1 provides information is described.

FIG. 3 is a diagram illustrating an overview of information provision processing performed between the terminal 2 or the vehicle server 3 and the management server 1.

In this example, a plurality of terminals 2 can receive information provision from the management server 1. The terminal 2 that receives the information provision may be a terminal owned by an end user (for example, an owner of a vehicle) or may be a terminal owned by a company.

The end user can acquire, via the terminal 2, information concerning a battery of the vehicle owned by the end user. For example, the end user can check certified energy (capacity) (SoCE), a safety degree (SoS), and the like of the battery mounted on the vehicle owned by the end user.

On the other hand, the company can acquire, via the terminal 2, within the scope of access authority set in the company, information concerning a battery dealt in by the company. For example, when a target company is a manufacturer of a vehicle and is permitted to access battery information for the vehicle manufactured by the own company, the company can acquire the battery information for the vehicle manufactured by the own company. However, when the company is not permitted to access private information such as location information of the vehicle, these pieces of information are sometimes excluded from provision targets.

Further, in the present embodiment, the access authority is differentiated between when the company is a responsible company and when the company is not a responsible company. The responsible company indicates a company having management responsibility for a manufactured battery. In the present specification, companies other than the responsible company are referred to as general companies. The responsible company may be, for example, a company having responsibility of supervising the other companies not to illegally dump a target battery or may be a company having responsibility of monitoring a safety state of the target battery.

When the target company is the responsible company, in addition to the authority described above, the target company is permitted to access information concerning management responsibility of the target battery. For example, when the target company has responsibility of supervising the other companies not to illegally dump batteries, the target company is permitted to access information (for example, a transfer certificate and a disposal certificate generated at the stages) for tracking the location of the target battery. When the target company has responsibility of monitoring a safety state of a battery, the target company is permitted to access information (for example, information concerning an internal resistance value, an abnormal capacity value, and physical damage) obtained by diagnosing a safety state of the target battery.

### Hardware configuration

Subsequently, hardware configurations of the apparatuses configuring the system are described.

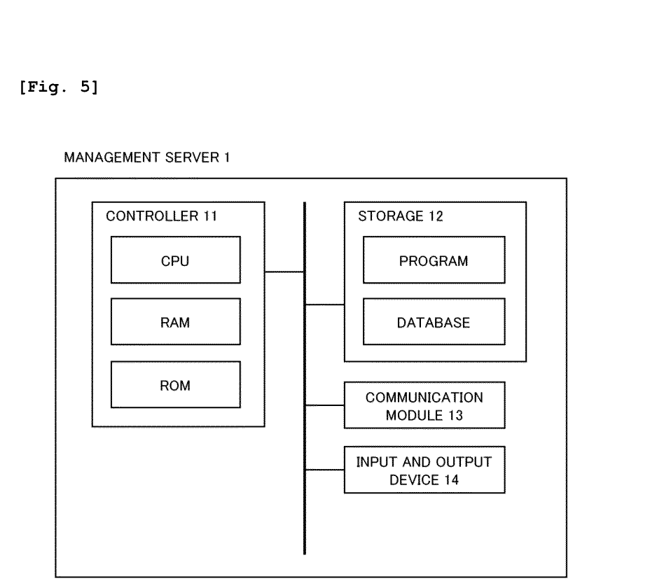

FIG. 5 is a diagram schematically illustrating an example of a hardware configuration of the management server 1 according to the present embodiment. The management server 1 is configured as a computer including a controller 11, a storage 12, a communication module 13, and an input and output device 14.

The management server 1 can be configured as a computer including a processor such as a CPU or a GPU, a main storage device such as a RAM or a ROM, and an auxiliary storage device such as an EPROM, a hard disk drive, or a removable medium. An operating system (OS), various programs, various tables, and the like are stored in the auxiliary storage device. Functions matching predetermined purposes described below can be implemented by executing the programs stored in the auxiliary storage device. However, some or all of the functions may be implemented by a hardware circuit such as an ASIC or an FPGA.

The controller 11 is an arithmetic operation unit that implements various functions of the management server 1 by executing a predetermined program. The controller 11 can be implemented by a hardware processor such as a CPU. The controller 11 may include a RAM, a ROM (Read Only Memory), and a cache memory.

The storage 12 is means for storing information and is configured by a storage medium such as a RAM, a magnetic disk, or a flash memory. Programs to be executed by the controller 11, data to be used by the programs, and the like are stored in the storage 12.

A database is constructed in the storage 12. Information concerning a battery collected from the plurality of terminals 2 (or the vehicle server 3) is stored in the database. Details are described below.

The communication module 13 is a communication interface for connecting the management server 1 to a network. The communication module 13 includes, for example, a network interface board and a wireless communication interface for wireless communication. The management server 1 can perform data communication with another computer (for example, the terminals 2) via the communication module 13.

The input and output device 14 is means for receiving input operation performed by an operator and presenting information to the operator. Specifically, the input and output device 14 includes devices for performing input such as a mouse and a keyboard and devices for performing output such as a display and a speaker. The input and output device may be integrally configured by, for example, a touch panel display.

Note that, in a specific hardware configuration of the management server 1, omission, substitution, and addition of components are possible as appropriate according to an embodiment. For example, the controller 11 may include a plurality of hardware processors. The hardware processors may be configured by a microprocessor, an FPGA, a GPU, and the like. The input and output device 14 may be omitted or an input and output device (for example, an optical drive) other than the exemplified one may be added. The management server 1 may be configured by a plurality of computers. In this case, hardware configurations of the computers may coincide or may not coincide.

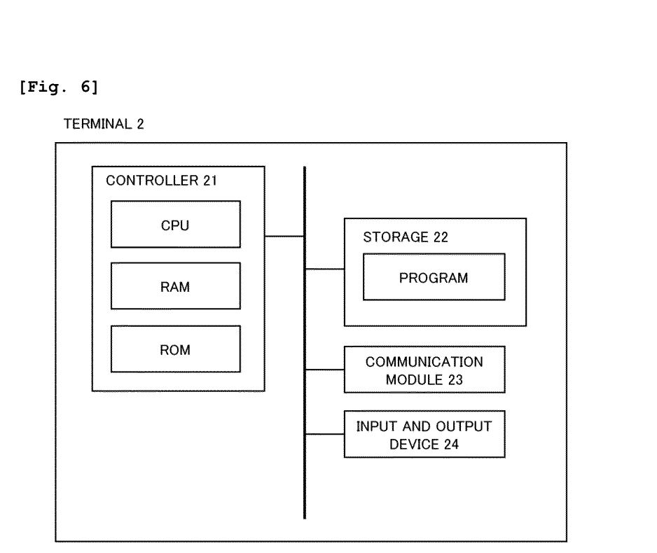

FIG. 6 is a diagram schematically illustrating an example of a hardware configuration of the terminal 2 according to the present embodiment. The terminal 2 is configured as a computer including a controller 21, a storage 22, a communication module 23, and an input and output device 24.

Like the management server 1, the terminal 2 can be configured as a computer including a processor such as a CPU or a GPU, a main storage device such as a RAM or a ROM, and an auxiliary storage device such as an EPROM, a hard disk drive, or a removable medium. However, some or all of the functions may be implemented by a hardware circuit such as an ASIC or an FPGA.

The controller 21 is an arithmetic operation unit that implements various functions of the terminal 2 by executing a predetermined program. The controller 21 can be implemented by a hardware processor such as a CPU. The controller 21 may include a RAM, a ROM (Read Only Memory), and a cache memory.

The storage 22 is means for storing information and is configured by a storage medium such as a RAM, a magnetic disk, or a flash memory. Programs to be executed by the controller 21, data to be used by the programs, and the like are stored in the storage 22.

The communication module 23 is a communication interface for connecting the terminal 2 to a network. The communication module 23 includes, for example, a network interface board and a wireless communication interface for wireless communication. The terminal 2 can perform data communication with another computer (for example, the management server 1) via the communication module 23.

The input and output device 24 is means for receiving input operation performed by an operator and presenting information to the operator. Specifically, the input and output device 24 includes devices for performing input such as a mouse and a keyboard and device for performing output such as a display and a speaker. The input and output device 24 may be integrally configured by, for example, a touch panel display.

Note that, in a specific hardware configuration of the terminal 2, like the management server 1, omission, substitution, and addition of components are possible as appropriate according to an embodiment.

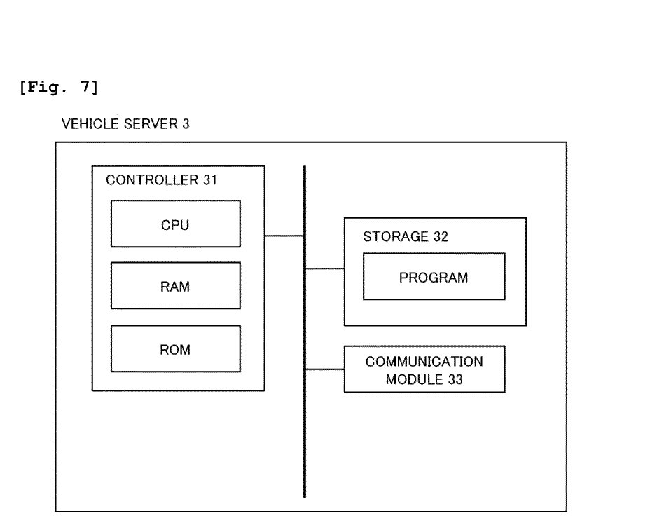

FIG. 7 is a diagram schematically illustrating an example of a hardware configuration of the vehicle server 3 according to the present embodiment. The vehicle server 3 is configured as a computer including a controller 31, a storage 32, and a communication module 33.

Like the management server 1, the vehicle server 3 can be configured as a computer including a processor such as a CPU or a GPU, a main storage device such as a RAM or a ROM, and an auxiliary storage device such as an EPROM, a hard disk drive, or a removable medium. However, some or all of the functions may be implemented by a hardware circuit such as an ASIC or an FPGA.

The controller 31 is an arithmetic operation unit that implements various functions of the vehicle server 3 by executing a predetermined program. The controller 31 can be implemented by a hardware processor such as a CPU. The controller 31 may include a RAM, a ROM (Read Only Memory), and a cache memory.

The storage 32 is means for storing information and is configured by a storage medium such as a RAM, a magnetic disk, or a flash memory. Programs to be executed by the controller 31, data to be used by the programs, and the like are stored in the storage 32.

The communication module 33 is a communication interface for connecting the vehicle server 3 to a network. The communication module 33 includes, for example, a network interface board and a wireless communication interface for wireless communication. The vehicle server 3 can perform data communication with another computer (for example, the management server 1 or an in-vehicle device mounted on the vehicle 10) via the communication module 33.

Note that, in a specific hardware configuration of the vehicle server 3, like the management server 1, omission, substitution, and addition of components are possible as appropriate according to an embodiment.

### Software configuration

Subsequently, software configurations of the apparatuses configuring the system are described.

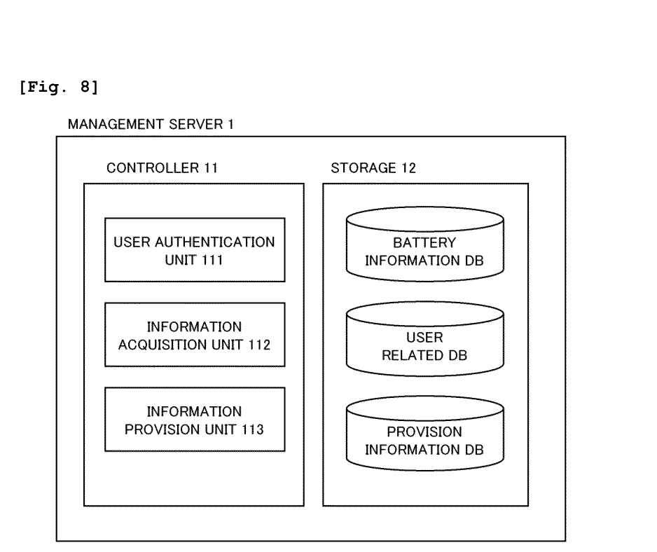

FIG. 8 is a diagram schematically illustrating a software configuration of the management server 1 according to the present embodiment.

In the present embodiment, the controller 11 includes three functional modules, that is, a user authentication unit 111, an information acquisition unit 112, and an information provision unit 113. The functional modules may be implemented by executing, with the controller 11 (the CPU), programs stored in the storage 12.

The user authentication unit 111 authenticates a user who is about to log in to the management server 1.

Data collected and provided by the management server 1 can change according to what kind of user uses the terminal 2 or which of the stages exemplified in FIG. 2 the user who uses the terminal 2 belongs to.

For example, users who use the management server 1 can be classified into a plurality of actors such as a "user (end user) of a vehicle", a "vehicle manufacturer", a "battery manufacturer", a "vehicle dealer", a "vehicle dismantler", and a "battery distributor". In the present embodiment, results of the classification are referred to as "actor classes". The same actor can be further classified into a plurality of attributes according to, for example, vehicle and battery manufacturers. In the present embodiment, results of the classification are referred to as "user classes". The management server 1 links, for each of the actor classes and the user classes, a user interface screen to be provided and provides an appropriate screen to the terminal 2.

The user authentication unit 111 may execute user authentication by itself or may acquire a result of user authentication performed by another system or apparatus. For example, when there is a plurality of companies that deal in a battery and user authentication is performed in units of companies, the user authentication unit 111 may acquire a result of user authentication from an authentication server provided for each of the companies.

Further, the user authentication unit 111 determines a user class of an accessing user using a database (a user related DB) concerning user authentication constructed in the storage 12.

In the present embodiment, operators of the companies log in to, via the terminals 2, the management server 1 using accounts of the companies corresponding to the operators, whereby interaction between the management server 1 and the terminal 2 is performed.

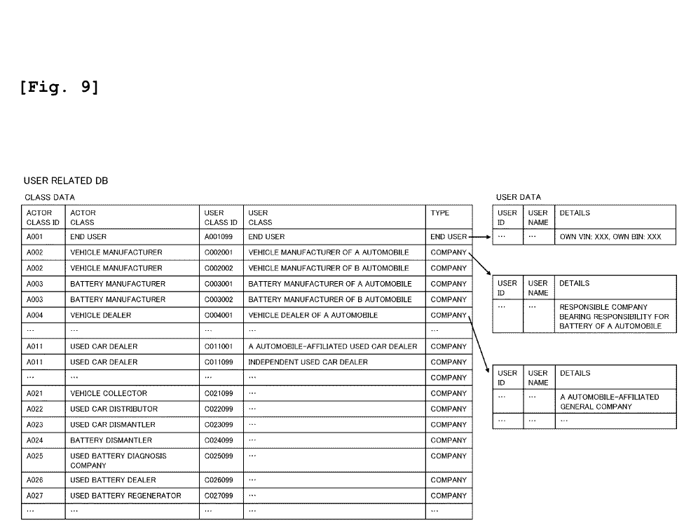

FIG. 9 is a diagram for explaining the user related DB. In the present embodiment, the user related DB is configured from class data and user data.

The user data is data defining an individual user. The class data is data defining an actor class and a user class. As illustrated, in the present embodiment, a plurality of actor classes such as an "end user", a "vehicle manufacturer", a "battery manufacturer", and a "vehicle dealer" is defined.

The user classes are correlated with the actor classes. The user classes are classes obtained by further subdividing the actor class into a plurality of attributes according to manufacturers and the like. In the illustrated example, for example, a logging in user is classified into a user class such as a "vehicle manufacturer of an A automobile" or a "vehicle manufacturer of a B automobile".

A plurality of users is correlated with the user classes. When a user class is the "end user", the user data may include information identifying a vehicle and a battery owned by a user.

The information acquisition unit 112 executes processing of acquiring information concerning a battery from the terminal 2 or the vehicle server 3 and storing the information in a database (a battery information DB) provided in the storage 12. In the following explanation, the information stored in the battery information DB is referred to as "battery information". The battery information is, for example, any one of the pieces of information of the plurality of types exemplified in FIG. 2.

The information acquisition unit 112 acquires data (the battery information) concerning the battery from a company or an end user.

When a provision source of the data is a company, the information acquisition unit 112 generates, for the terminal 2 used by the company, a user interface screen for causing the company to input collection target data and acquires data input via the user interface screen. The user interface screen provided to the terminal 2 is determined based on a actor class determined by the user authentication unit 111.

For example, for a user, whose user class is the "battery manufacturer", the information acquisition unit 112 provides a user interface screen for causing the user to input information concerning a carbon footprint of a battery to be manufactured, information concerning recycling, information concerning due diligence, and the like.

For a user, whose actor class is the "battery distributor", the information acquisition unit 112 provides a user interface screen for causing the user to input information concerning a carbon footprint of a target battery, information concerning a model of the battery, a diagnosis result of the battery, information concerning a transfer certificate of the battery, and the like.

The information acquisition unit 112 generates a user interface screen different for each of the actor classes and provides the user interface screen to the terminal 2. A user of the terminal 2 inputs, via the user interface screen, information provided to the management server 1.

In some cases, an information provision source is not a company and is an end user. For example, when an end user of a vehicle agrees beforehand with provision of information for monitoring a battery, information acquired by the vehicle is transmitted to the information acquisition unit 112 via the vehicle server 3. In this case, a user interface screen is not used.

For example, the vehicle can transmit information indicating an SoC (state of charge) of the battery to the management server 1. Note that the information transmitted from the vehicle may be processed in the management server 1 or the vehicle server 3. For example, the management server 1 (the vehicle server 3) may acquire information indicating a traveling load, a current value, a voltage value, a change rate of an SoC of a target vehicle and calculate an SoCE (state of certified energy) of the target vehicle based on the information. A logic for the calculation may be a logic stored beforehand or may be a logic provided from a company as a part of battery information.

Subsequently, details of data acquired by the information acquisition unit 112 are described.

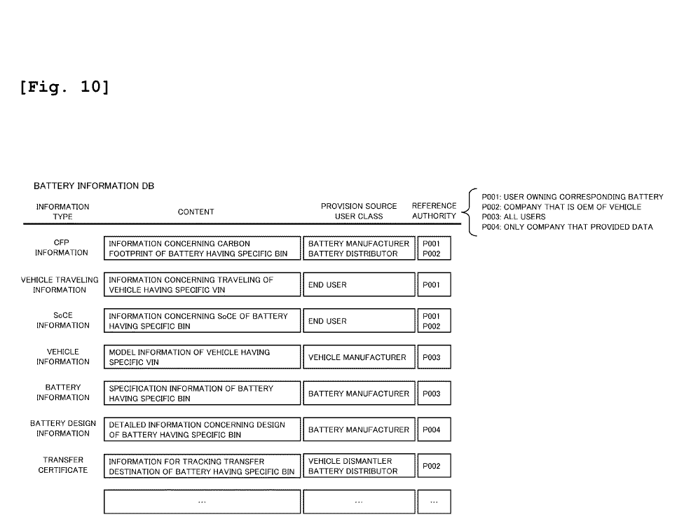

FIG. 10 is an example of battery information stored in the battery information DB. As described above, the information acquisition unit 112 collects information concerning a plurality of types different from one another from users respectively belonging to a plurality of actor classes and user classes and stores the information in the battery information DB. For example, the information acquisition unit 112 acquires information concerning a carbon footprint (CFP) of a battery from a user belonging to a actor class of the "battery manufacturer" or the "battery distributor" and stores the information in the battery information DB as an information type of "CFP information".

Types of reference authority different from one another are respectively imparted to data stored in the battery information DB. The reference authority is described below.

Note that an example in which the information acquisition unit 112 acquires information from the terminal 2 or the vehicle server 3 is cited above. However, an acquisition destination of information is not limited to this. For example, when the management server 1 is connected to another system that oversees companies relating to manufacturing and distribution of a battery, battery information may be acquired from the other system.

The information provision unit 113 executes processing of extracting, based on a request from the terminal 2, battery information stored in the battery information DB and providing the battery information to the terminal 2.

As described above, in the present embodiment, the management server 1 classifies the users who use the terminal 2 into the plurality of actor classes and user classes. Like the information acquisition unit 112, the information provision unit 113 provides a different user interface screen to the terminal 2 for each of the actor classes. The user who uses the terminal 2 can receive the provision of the battery information via the user interface screen provided by the information provision unit 113.

Note that the information provision unit 113 may directly provide the battery information stored in the battery information DB to the terminal 2 or may perform processing or an arithmetic operation on the battery information and then provide the battery information to the terminal 2. The information subjected to the processing or the arithmetic operation is also sometimes referred to "battery information" in the present specification.

In the present embodiment, the management server 1 stores data (provision information DB) defining what kind of information is provided to a user belonging to which actor class/user class. The information provision unit 113 generates, based on the data, a user interface screen for providing battery information.

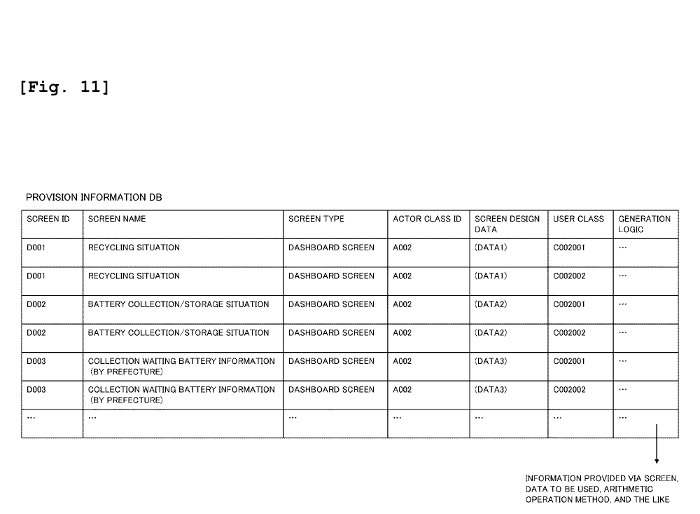

FIG. 11 is an example of information stored in the provision information DB. The provision information DB is a database defining, in units of screens, information that can be provided to a user belonging to a specific actor class and a specific user class. In the illustrated example, the provision information DB defines three screens of a "recycling situation", a "battery collection/storage situation", and "collecting waiting battery information (by prefecture)" being able to be provided to a user belonging to an actor class of a "vehicle manufacturer (A002)". Design data for generating these screens and a logic (data to be used and an arithmetic operation method) for generating information provided via these screens is defined.

In the illustrated example, when an actor class of a user is the same, design of a screen to be provided is also the same. Note that, when an actor class of a user is different, design of a screen to be provided can also be different.

Accordingly, for example, it is possible to differentiate information provided to a user belonging to a certain actor class and information provided to a user belonging to a different actor class. For example, it is possible to take measures to differentiate information provided to a user belonging to an actor class having an ID "A002" and information provided to a user belonging to an actor class having an ID "A003". It is possible to take measures not to provide, to the user belonging to the actor class having the ID "A003", part of the information provided to the user belonging to the actor class having the ID "A002".

Note that, when an actor class is the same but a user class is different, information provided via a screen can change. For example, even if the screen of the "recycling situation" is the same, a "recycling situation concerning a battery of the A automobile" is sometimes provided to a user whose user class is "C002001" and a "recycling situation concerning a battery of the B automobile" is sometimes provided to a user whose user class is "C002002".

When there is access from the terminal 2, the information provision unit 113 determines an actor class and a user class of a user relating to the access and determines, based on the determined actor class, which screen can be provided to the user. The information provision unit 113 may generate a menu including a list of screens that can be provided and provide the menu to the terminal 2.

When a specific screen is designated, the information provision unit 113 determines, based on the determined user class, which information is embedded in the screen and provided. The information provision unit 113 extracts, based on a result of the determination, battery information stored in the battery information DB, generates a screen in which provision target information is embedded, and provides the screen to the terminal 2.

Subsequently, a software configuration of the terminal 2 according to the present embodiment is described.

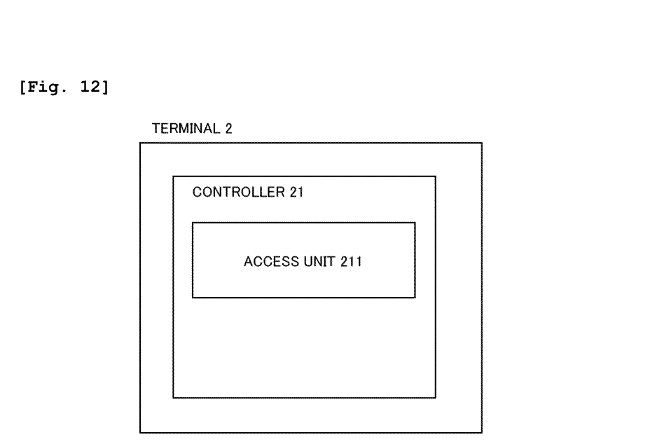

FIG. 12 is a diagram schematically illustrating the software configuration of the terminal 2 according to the present embodiment.

In the present embodiment, the controller 21 includes an access unit 211 as a functional module. The functional module may be implemented by executing, with the controller 21 (the CPU), a program stored in the storage 22.

The access unit 211 executes a function of accessing the management server 1 and performing interaction. The function may be implemented by a Web browser operating in the terminal 2 or dedicated application software. The access unit 211 outputs a user interface screen generated by the management server 1 and inputs and outputs information via the screen.

Subsequently, a software configuration of the vehicle server 3 according to the present embodiment is described.

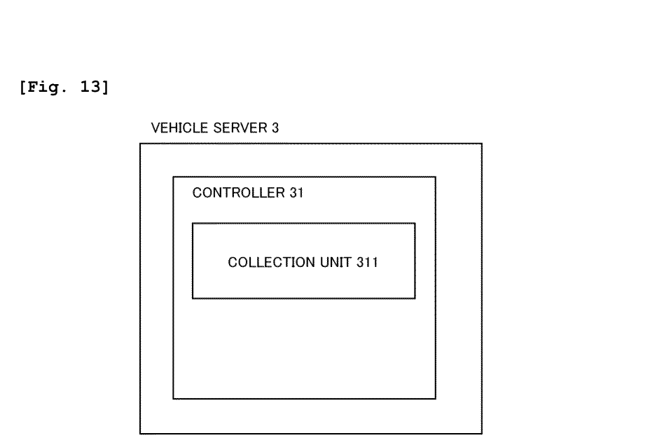

FIG. 13 is a diagram schematically illustrating the software configuration of the vehicle server 3 according to the present embodiment.

In the present embodiment, the controller 31 includes a collection unit 311 as a functional module. The functional module may be implemented by executing, with the controller 31 (the CPU), a program stored in the storage 32.

The collection unit 311 performs communication with a plurality of vehicles 10 that are under the control of the controller 31 and collects information concerning traveling (vehicle traveling information) from the plurality of vehicles 10. The collection unit 311 transmits the collected vehicle traveling information or battery information generated based on the vehicle traveling information to the management server 1. For example, the collection unit 311 may perform predetermined arithmetic processing (for example, processing of estimating an SoCE value) on the collected vehicle traveling information and convert the vehicle traveling information into information (for example, an SoCE value) concerning the battery and then transmit the information to the management server 1.

### Example of a user interface screen to be provide

Subsequently, an example of a user interface screen provided from the management server 1 to the terminal 2 is described. In the present embodiment, the management server 1 is configured to be capable of providing information to the terminal 2 via three types of screens described below.

### (1) Dashboard screen

A dashboard screen is a screen for providing statistical information concerning a battery dealt in by a company.

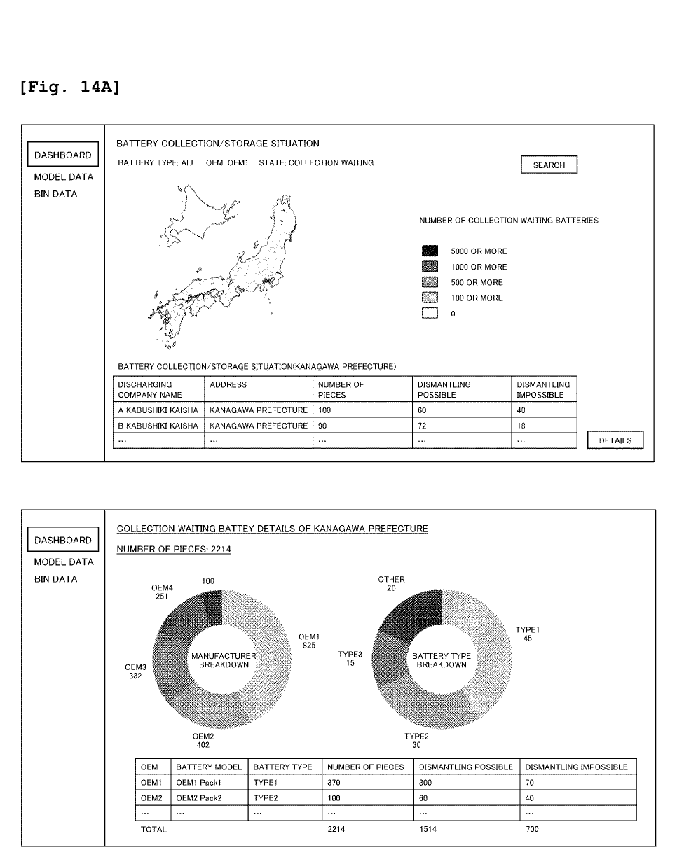

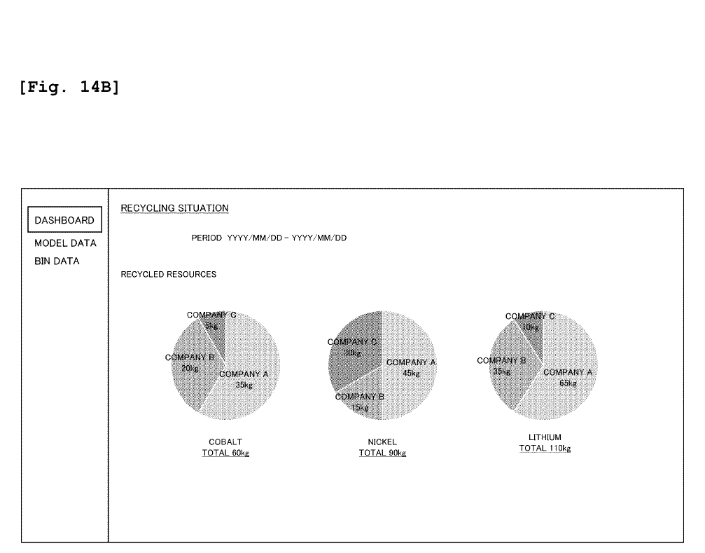

For example, it is assumed that a company logging in to the management server 1 is a company that performs redistribution of a battery removed from a scrapped car. In this case, the company can obtain, from the management server 1, statistical information concerning, for example, a collection situation, a storage situation, and distribution for each region of a battery dealt in by the own company. FIG. 14A is an example of the dashboard screen. In the illustrated example, a collection situation and a storage situation for each region of a target battery are illustrated. The company can check, by designating a region, how many batteries are present in which dismantler or information such as a breakdown of manufacturers and types. The screen can be generated based on battery information transmitted from a company that dismantles a scrapped car and collects a battery.

For example, it is assumed that a company logging in to the management server 1 is a company that manufactured a battery. In this case, the company can obtain, for example, statistical information concerning a recycle situation of the battery manufactured by the own company. FIG. 14B is another example of the dashboard screen. In the illustrated example, for a target battery, a situation of recycling for each resource is illustrated. The screen can be generated based on battery information transmitted from a company that dismantles a battery and performs recycling.

### (2) Model data screen

A model data screen is a screen for providing information concerning a specific model of a battery.

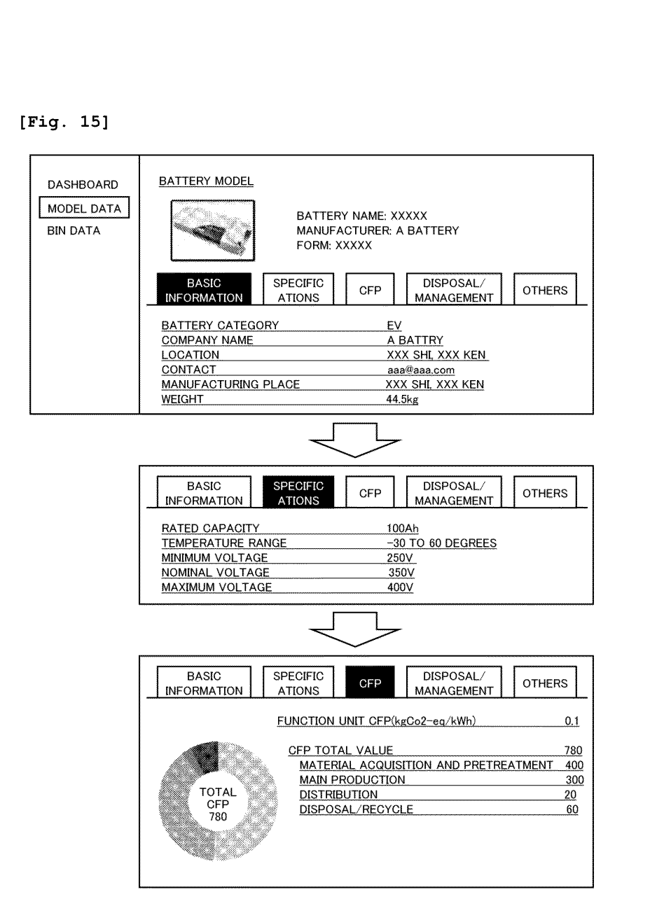

The model data screen is a screen for providing public information for the specific model of the battery. A plurality of companies involved in the battery can access the model data screen. FIG. 15 is an example of the model data screen. In the illustrated example, information concerning a battery of a designated model is illustrated. On the model data screen, for example, basic information of the battery, specifications of the battery, carbon footprint information, and information concerning a method of disposal and management can be checked. The screen can be generated based on battery information transmitted from a company that designed and manufactured the battery.

### (3) BIN data screen

A BIN data screen is a screen for providing information concerning a specific individual of a battery.

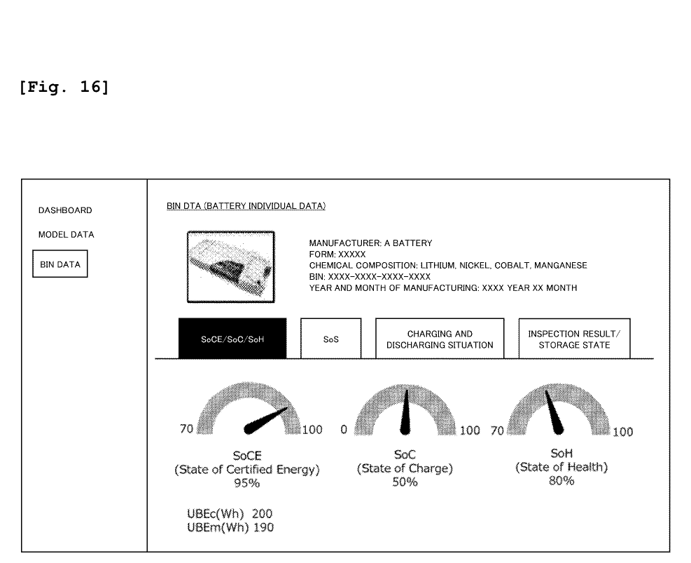

The BIN data screen is a screen for providing status information about the specific individual of the battery. Typically, an end user owning the battery and a company bearing management responsibility for the battery can access the BIN data screen. FIG. 16 is an example of the BIN data screen. In the illustrated example, information concerning a status of a battery having a designated BIN (Battery Identification Number) is illustrated. On the BIN data screen, for example, certified energy (capacity) (SoCE, state of certified energy), a safety degree (SoS, state of safety), a health degree (SoH, state of health), information concerning a situation of charging and discharging, and inspection result information of the battery are provided. The screen can be generated based on information transmitted from a target vehicle via the vehicle server 3.

### Reference authority for battery information

Subsequently, authority for referring to data stored in the battery information DB is described.

In order to generate the screens described above, necessary battery information needs to be extracted from the battery information DB. However, if reference to data is permitted without limitation, it could occur that even information unpreferable in protection of privacy is disclosed. For example, it is conceivable that a company (an OEM) bearing management responsibility for a battery accesses the BIN data screen and checks a health degree and a safety degree of a target battery. However, when the BIN data screen includes information concerning privacy of a target battery (vehicle) (for example, traveling information of the vehicle), it is unpreferable to provide the information to the OEM. Thus, in the present embodiment, reference authority is imparted to each user for each of pieces of battery information stored in a database.

The reference authority is described with reference to FIG. 10 illustrating a configuration of the battery information DB.

In the present embodiment, the reference authority is imparted to battery information for each information type. In the illustrated example, four types of reference authority of a "user owning a target battery", a "company that is an OEM of a vehicle", "all users", and a "company that provided data" are defined. The reference authority is imparted at timing for storing battery information anew.

For example, carbon footprint information about a certain battery can be referred to from an end user owning the battery and a company that is an OEM of a vehicle. On the other hand, since information concerning traveling of the vehicle (vehicle traveling information) can include private information, the information can be referred to only from an end user of the vehicle. Since information concerning models (specifications) of the vehicle and the battery (vehicle information and battery information) are public information, the information can be referred to from all users. On the other hand, since information concerning design of the battery (battery design information) includes secret information, the information can be referred to only from a company that provided data.

Besides, information concerning a chemical composition of cathode active materials such as a composition ratio of nickel, cobalt, and manganese sometimes can be referred to from, for example, a company that recycles the battery. Information concerning dismantling (secondary dismantling) for extracting modules and cells from a battery pack sometimes can be referred to from a specific company.

As described above, in the present embodiment, the reference authority is imparted respectively for the pieces of battery information store in the database to allow the users to acquire information within a scope of the imparted authority.

Note that, to a user owning a vehicle and a battery, the reference authority is at least imparted for information (first information) concerning a status of the battery. Note that, when the ownership of the vehicle has been transferred, for example, when the user has sold the vehicle, the reference authority imparted to the user may be deleted to disable the user to access information in the past (an owning period).

To a user (an OEM or the like) having management responsibility for a battery, the reference authority is at least imparted for information (second information) belonging to a scope of the management responsibility for the battery.

When the management responsibility for the battery is responsibility for safety, the "information belonging to the scope of the management responsibility for the battery" means information concerning a health degree and a safety degree of the battery and means, for example, an inspection result of the battery and information indicating a deterioration degree of the battery. These pieces of information include, for example, information concerning an effective capacity of the battery, information concerning the temperature of the battery, information concerning physical damage to the battery, and information concerning internal resistance of the battery.

When the management responsibility for the battery is responsibility for disposal, the "information belonging to the scope of the management responsibility for the battery" means, for example, information for tracking the location of the battery such as a transfer certificate of the battery or information indicating that the battery was disposed in a correct procedure such as a disposal certificate for the battery. The transfer certificate and the disposal certificate may include information indicating a transferer, a transferee, a disposal method, or a disposal place.

### Processing flow

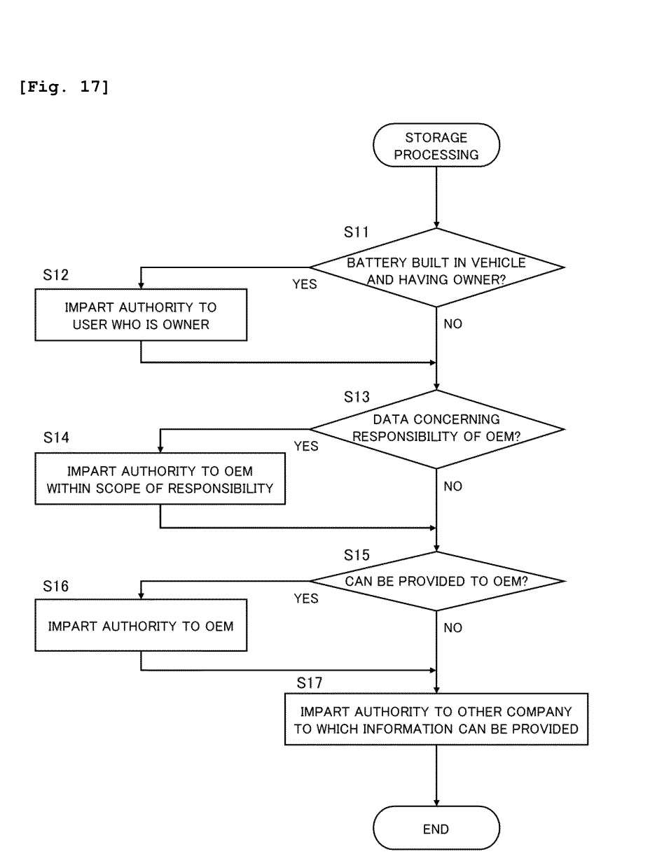

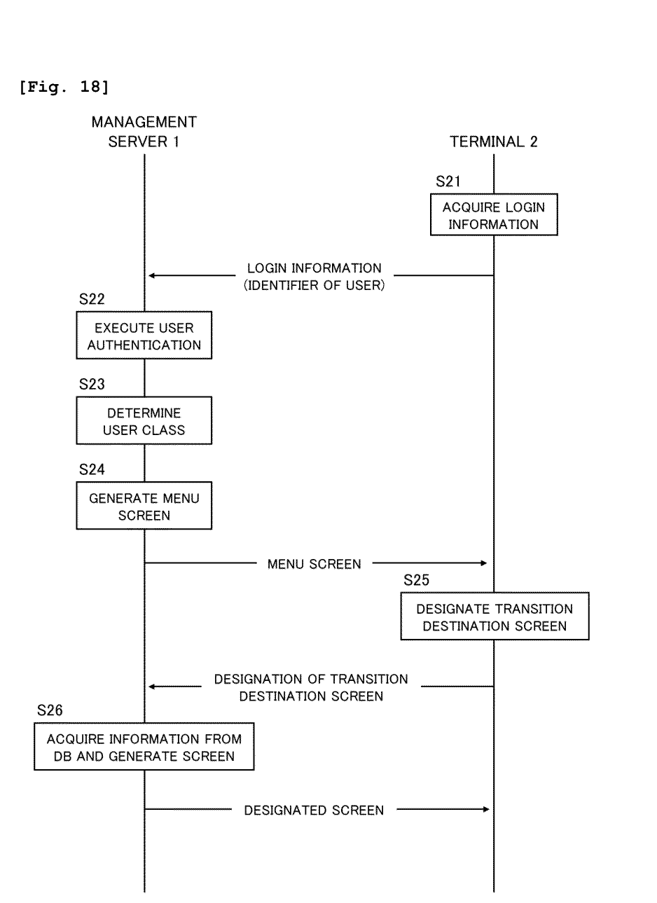

Subsequently, a flow of processing executed by the management server 1 and the terminal 2 is described with reference to FIGS. 17 and 18. FIG. 17 is a flowchart of processing in which the management server 1 imparts reference authority for battery information acquired anew. The illustrated processing is executed by the information acquisition unit 112 when the management server 1 receives battery information from the terminal 2 or the vehicle server 3 and stores the battery information in a database.

First, in step S11, the information acquisition unit 112 determines whether battery information to be stored is information concerning a battery built in a vehicle and having an owner. When a target battery is built in the vehicle and has an owner, the processing transitions to step S12. When the target battery is not built in the vehicle, the processing transitions to step S13.

In step S12, the information acquisition unit 112 imparts, for the battery information to be stored, reference authority to a user, who is the owner.

In step S13, the information acquisition unit 112 determines whether the battery information to be stored is information concerning a battery for which a specific OEM bears management responsibility. When the battery information to be stored is information concerning a battery for which a specific OEM bears management responsibility, the processing transitions to step S14. When the battery information to be stored is not information for which a specific OEM bears the management responsibility, the processing transitions to step S15.

In step S14, the information acquisition unit 112 imparts reference authority to a user, who is an OEM having management responsibility for the target battery. Note that the imparting of the reference authority may be performed within a scope of responsibility.

In step S15, the information acquisition unit 112 determines whether information to be stored is information that can be provided to an OEM that manufactured the target battery. When the information to be stored can be provided to the OEM that manufactured the target battery, the processing transitions to step S16. When the information to be stored cannot be provided to the OEM that manufactured the target battery, the processing transitions to step S17.

Note that, even the OEM that manufactured the target battery cannot always access all pieces of battery information. For example, the latest SoCE value or the like needs to be calculated based on data collected from the vehicle. However, when a data provision contract has not been concluded with an owner of the vehicle, since data cannot be lawfully collected, an SoCE value cannot be provided to the OEM. Even when the data provision contract has been concluded, when the ownership of the vehicle has been transferred (for example, the vehicle has been sold as a used car), an SoCE value cannot be provided to the OEM after the transfer.

In step S15, possibility of authority imparting is determined considering such a situation as well.

In step S16, for the information to be stored, the information acquisition unit 112 imparts reference authority to the user, who is the OEM that manufactured the target battery.

In step S17, for the information to be stored, the information acquisition unit 112 imparts reference authority to a user, who is another company to which the information can be provided. When another rule concerning the reference authority such as "provide information concerning a recycle situation of a dealing target battery to a company that performs recycling of a battery" is present, the imparting of the reference authority is performed in this step within a scope of the rule.

Note that it is assumed that the processing illustrated in FIG. 17 is executed at timing when given battery information is stored. However, the illustrated processing may be executed at timing other than the timing. For example, as described above, when the ownership of the vehicle mounted with the target battery has been transferred, the OEM of the vehicle sometimes cannot access specific battery information. Thus, the processing illustrated in FIG. 17 may be executed again to update the reference authority at such timing concerning the transfer of the ownership or timing when a stage has changed.

Subsequently, processing in which the management server 1 performs information provision to the terminal 2 based on information stored in the battery information DB is described. FIG. 18 is a sequence chart corresponding to processing in which the management server 1 performs information provision to the terminal 2.

Interaction between the management server 1 and the terminal 2 is started when an operator of each company (or an end user) logs in to the management server 1 via the terminal 2 using an account corresponding to the operator (or the end user).

First, in step S21, the terminal 2 (the access unit 211) acquires information (login information) for authenticating a user. The login information may be a password or the like or may be an access token or the like. The acquired login information is transmitted to the management server 1 (the user authentication unit 111). In step S22, the user authentication unit 111 executes authentication of the user.

Note that, in this example, it is assumed that the terminal 2 transmits the login information to the management server 1. However, the authentication of the user may be performed by an external system (for example, an authentication platform). In this case, the user authentication unit 111 receives an authentication result from the external system and identifies the user relating to the access based on the authentication result.

In step S23, the user authentication unit 111 determines an actor class and a user class of the user relating to the access. The actor class and the user class can be determined based on the user related DB stored in the storage 12. As described with reference to FIG. 11, the actor class is correlated with a screen that can be provided to a relevant user and the user class is correlated with information provided via the screen.

In step S24, the user authentication unit 111 determines, based on a determination result in step S23, a screen that can be provided to the user and generates a menu screen for accessing the screen. The menu screen includes a menu for transitioning to one or more screens accessible from the user. The screen accessible from the user belongs to at least any one of the dashboard screen, the model data screen, and the BIN data screen. The generated menu screen is provided to the terminal 2.

In step S25, the user selects a transition destination screen from the menu in the terminal 2. When the transition destination screen is selected, designation of the transition destination screen is transmitted to the management server 1. The information provision unit 113 acquires information from the battery information DB based on the designation and generates a screen (step S26). For the generation of the screen, screen design data stored in the provision information DB is used. Note that, when a target screen includes reference to data without reference authority, the data is omitted. The generated screen is transmitted to the terminal 2 and provided to the user.

As described above, the management server 1 according to the present embodiment collects the information concerning the battery from the plurality of companies or the end user involved in the lifecycle of the battery and centrally manages the information. The management server 1 classifies the user relating to the access according to the actor class and the user class and determines, based on a result of the classification, a screen and information to be provided. With the configuration described above, it is possible to improve efficiency of screen display control and it is possible to provide appropriate information to users having various attributes.

### Modifications

The embodiments described above are only examples. The present disclosure can be changed and implemented as appropriate without departing from the gist of the present disclosure.

For example, the processing and the means described in the present disclosure can be freely combined and implemented as long as technical contradiction does not occur.

In the explanation of the embodiments, the management server 1 stores the battery information in the database. However, the battery information may be stored by means other than the database.

Furthermore, a process described as being performed by one apparatus may be shared and executed by a plurality of apparatuses. Or alternatively, processes described as being performed by different apparatuses may be executed by one apparatus. In a computer system, in what hardware configuration (a server configuration) each function is realized can be flexibly changed.

The present disclosure can be realized by supplying a computer program implemented with the functions described in the above embodiment to a computer, and one or more processors of the computer reading out and executing the program. Such a computer program may be provided for the computer by a non-transitory computer-readable storage medium connectable to the system bus of the computer or may be provided for the computer via a network. As the non-transitory computer-readable storage medium, for example, any type of disk such as a magnetic disk (a floppy (registered trademark) disk, a hard disk drive (HDD), or the like) or an optical disc (a CD-ROM, a DVD disc, a Blu-ray disc, or the like), and any type of medium that is appropriate for storing electronic commands like a read-only memory (ROM), a random access memory (RAM), an EPROM, an EEPROM, a magnetic card, a flash memory, or an optical card are included.

What is claimed is:

1. A system comprising:
a terminal; and
a server; wherein
the terminal is configured to transmit a signal including battery information to the server, and
the server includes:
a storage configured to store:
a first database which associates user ids with user classes; and
a second database which associates user classes with provision information; and
a processor configured to execute:
when there is a request signal including a user id from a user, identifying the user class corresponding to the user id stored in the first database;
retrieving the provision information corresponding to the user class stored in the second database;
generating, based on the provision information, a user interface screen corresponding to the identified user class; and
outputting the generated user interface screen to a terminal of the user.

2. An information processing apparatus that provides first information concerning a predetermined target object to a user, the first information being generated based on one or more pieces of data concerning the predetermined target object, the information processing apparatus comprising:
a storage configured to store:
the one or more pieces of data;
user data that is data defining a user accessing the information processing apparatus in association with a user class; and
second information defining the first information that can be provided to a user belonging to a predetermined user class; and
a processor configured to execute:
when there is access from a user, determining, based on the user data, a user class corresponding to the user;
generating, based on the second information, the first information corresponding to the determined user class; and
outputting the generated first information to a terminal of the user.

3. An information processing apparatus that provides first information concerning a predetermined target object to a user, the first information being generated based on one or more pieces of data concerning the predetermined target object, the information processing apparatus comprising a processor configured to execute:
when there is access from a user, determining, out of a plurality of user classes defined in advance, a user class corresponding to the user;
generating, based on second information defining the first information that can be provided to the user belonging to the predetermined user class, the first information corresponding to the determined user class; and
providing the generated first information to the user.

4. The information processing apparatus according to claim 3, wherein
the first information is provided in units of screens, and
the second information is information defining design of a screen provided to the user belonging to the predetermined user class and the first information provided on the screen.

5. The information processing apparatus according to claim 3, wherein the second information includes a generation logic for the first information that uses the one or more pieces of data.

6. The information processing apparatus according to claim 3, further comprising a storage configured to store the one or more pieces of data.

7. The information processing apparatus according to claim 6, wherein the storage further stores the second information.

8. The information processing apparatus according to claim 3, wherein the predetermined target object is a battery mounted on a predetermined vehicle.

9. The information processing apparatus according to claim 8, wherein the first information includes information concerning a deterioration degree of the battery.

10. An information processing method executed by an information processing apparatus that provides first information concerning a predetermined target object to a user, the first information being generated based on one or more pieces of data concerning the predetermined target object, the information processing method comprising:
when there is access from a user, determining, out of a plurality of user classes defined in advance, a user class corresponding to the user;
generating, based on second information defining the first information that can be provided to a user belonging to a predetermined user class, the first information corresponding to the determined user class; and
providing the generated first information to the user.

11. The information processing method according to claim 10, wherein
the first information is provided in units of screens, and
the second information is information defining design of a screen provided to the user belonging to the predetermined user class and the first information that can be provided.

12. The information processing method according to claim 10, wherein the second information includes a generation logic for the first information that uses the one or more pieces of data.

13. The information processing method according to claim 10, wherein the one or more pieces of data are acquired from a storage device included in the information processing apparatus.

14. The information processing method according to claim 13, wherein the second information is further acquired from the storage device.

15. The information processing method according to claim 10, wherein the predetermined target object is a battery mounted on a predetermined vehicle.

16. The information processing method according to claim 15, wherein the first information includes information concerning a deterioration degree of the battery.

17. A non-transitory storage medium recording a program for causing a computer to execute the information processing method according to claim 10.

18. A non-transitory storage medium recording a program for causing a computer to execute the information processing method according to claim 11.

19. A non-transitory storage medium recording a program for causing a computer to execute the information processing method according to claim 12.

20. A non-transitory storage medium recording a program for causing a computer to execute the information processing method according to claim 13.
